(19) United States
(12) Patent Application Publication
(10) Pub. No.: US 2012/0030197 A1
(43) Pub. Date: Feb. 2, 2012

(54) METHOD AND SYSTEM FOR REAL-TIME ONLINE COMMENTATOR DEBATE

(76) Inventor: Shahar ATTIAS, Binyamina (IL)

(21) Appl. No.: 12/843,911

(22) Filed: Jul. 27, 2010

(51) Int. Cl. G06F 17/30; G06F 3/00

(52) U.S. Cl. 707/723; 715/753; 707/E17.084

(57) ABSTRACT

A method and a system for an online commentary debate. Two or more commentators are selected to participate in the debate. Transmissions from each participant are received at a server and relayed to the other participant. The transmissions also are broadcast to an online forum that is viewable by an audience that can provide feedback on the debate and rate the commentators.

### FIELD AND BACKGROUND OF THE INVENTION

The present invention relates to an online debating tool and, more particularly, to a tool for pairing rival commentators for the purpose of debating a current event.

Event commentators, and specifically sport events commentators, are a permanent fixture in the entertainment and news industries. Most sport events which are televised and broadcast live have professional commentators who provide commentary concurrent to the sporting event. In recent years, with the development of online streaming technologies, televised events and commentaries can be viewed over the Internet. In addition, written commentaries are also available on the Internet, replacing and/or supplementing the post-event commentary found in the printed newspapers and journals.

It is hereby made clear that the content of the current application applies equally to all types of events where it would be relevant for people to commentate about the event. For the sake of clarity, sporting events will be used primarily herein, to effectively illustrate the nature of the innovative system.

Various attempts have been made to provide online, real-time commentary systems. U.S. patent application Ser. No. 11/966,072 describes a commentary technology for providing users with live text commentary. This application however, does not provide a platform for matching commentators who support rival teams or have opposing views, to debate the live event. The application is limited to text based commentary.

It would be highly advantageous to have an online forum where potentially remotely located commentators are matched together, based on various parameters such as, but not limited to, opposing views, language, skill, etc., to provide a debate style commentary regarding a current event. It would furthermore be advantageous to have such commentary in an audible or audio/visual format.

### Definitions

For the sake of clarity terms commonly used in this document are herein defined: The terms ‘commentator’, ‘debating participant’ and ‘participant’ are used interchangeably to refer to participant taking place in debates. The terms ‘audience member’, ‘viewer’ and ‘user’ are used interchangeably to refer to individuals who visit the online forum, listen/view the debate, provide ranking, comments and feedback, but do not participate in the debate itself.

### SUMMARY OF THE INVENTION

The current invention provides, at least, a tool for commentators, whether professional or amateur, to have a commentary debate against each other, where each commentator preferably represents one of the two opposing teams or groups participating in a particular event, such as a sporting game. Potentially, more than two commentators can participate in a debate and/or more than two teams can be taking part in the event whether represented by commentator or not. Exemplarily, cycling, swimming, poker and other multi-contender or multi-team games can be debated by two or more commentators.

According to the present invention there is provided an innovative method for providing an online commentary debate including the steps of: (a) selecting the first and second participant; (b) receiving the first set of transmissions from the selected first participant and relaying the first set of transmissions to the selected second participant; (c) receiving a second set of transmissions from the second participant and relaying the second set of transmissions to the first participant; and (d) broadcasting both sets of transmissions to an online forum on an internetwork, such as the Internet, substantially simultaneously to the reception of the transmissions.

According to further features in preferred embodiments of the invention there is provided a step for receiving and relating transmissions from at least one additional participant to and from the first and second participants.

According to still further features in the described preferred embodiments there is provided a step of receiving audience feedback, via an interface for receiving the feedback on the online forum. According to further features, there is provided a step of displaying the audience feedback on the interface, such as a webpage on a website.

According to further features there is provided a further step of receiving respective ranking feedback of the participants from the audience. According to further features there is provided a step of assigning respective ranking to the participants based on the ranking feedback, which is calculated based on a number of indicators such as ranking from likeminded audience members, ranking from non-likeminded audience members, the number of debates the participant has participated in, the previous ranking of the participant, ranking from audience members of the debates participated in by the participant, the number of audience members in attendance of the debated the participant participated in and the ratio of microphone usage by the participant during the debate.

According to further features there is provided a step of assigning initial rankings to the participants.

According to still further features the selection of the participants is effected by a technique selected from the list of: (a) randomized selection based on ranking similarities; (b) audience member proposition; and (c) direct request by at least one of the participants.

According to some embodiments of the present invention, the transmissions include audio content.

According to another embodiment the transmissions include audio and video content.

According to the present invention there is provided a system for broadcasting a commentary debate, comprising a server configured: (a) to select a first and second participant; (b) to receive a first transmission from the first selected participant and relay the first transmission to a second selected participant; (c) to receive a second transmission from the second participant and relay the second transmission to the first participant; and (d) to broadcast both sets of transmissions to an online forum on an internetwork, substantially simultaneously to the reception of the transmissions.

According to further features in preferred embodiments of the invention the server is further configured to receive feedback from an audience and display the feedback to the online forum.

According to still further features the server is configured to receive participant ranking from the audience.

According to the present invention there is provided a computer-readable medium operative to provide a system for broadcasting a commentary debate including: (a) a matching module for selecting a first and second participant; (b) a transmission module for receiving a first transmission from the first participant and relaying the first transmission to the second participant; (c) the transmission module for receiving a second transmission from the second participant and relaying the second transmission to the first participant; and (d) a broadcasting module for broadcasting both sets of transmissions to an online forum on an internetwork, substantially simultaneously to the reception of the transmissions.

According to further features in preferred embodiments of the invention there is provided a feedback module for receiving audience feedback via the online forum and displaying the feedback on the online forum.

According to still further features there is provided a ranking module for receiving ranking information from an audience via the online forum and calculating a participant ranking based on the ranking information.

### BRIEF DESCRIPTION OF THE DRAWINGS

Various embodiments are herein described, by way of example only, with reference to the accompanying drawings, wherein:

FIG. 1 is a schematic block diagram of a preferred embodiment of the innovative system;

FIG. 2 is a simplified illustration of an exemplary online forum audience view;

FIG. 3 is a simplified illustration of an exemplary online forum commentator view;

FIG. 4 is a simplified illustration of an exemplary selection webpage of the online forum;

FIG. 5 is a software embodiment of server 100.

### DESCRIPTION OF THE PREFERRED EMBODIMENTS

The principles and operation of an online debate system according to the present invention may be better understood with reference to the drawings and the accompanying description.

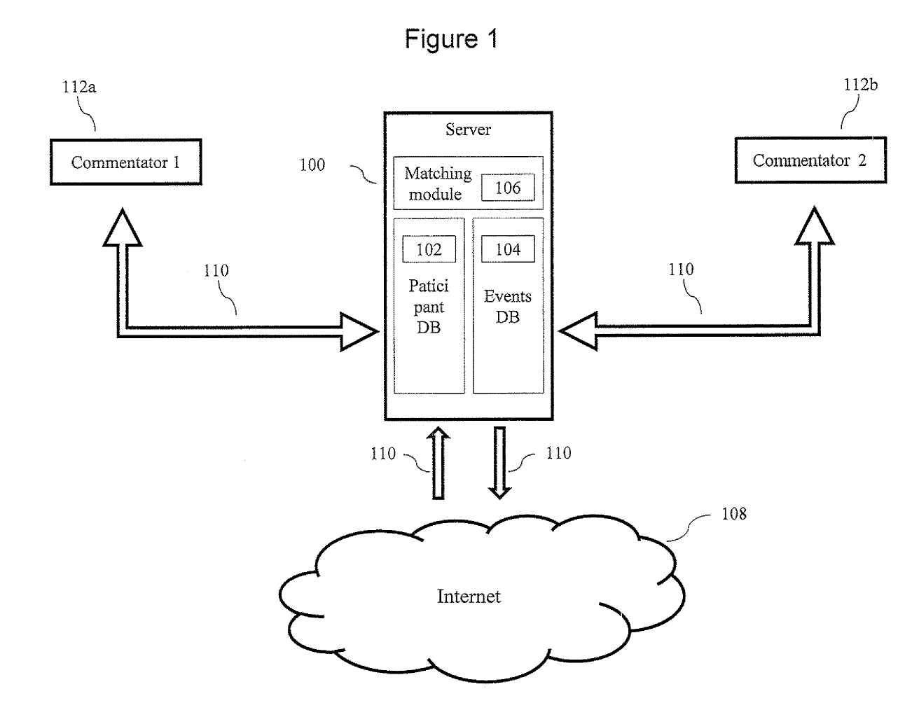

Referring now to the drawings, FIG. 1 illustrates a schematic block diagram of a preferred embodiment of the innovative system. Server 100 retains a Participant Database 102 of debate participants. Individuals are able to register to partake in debates. Exemplarily, an individual interested in commentating on a sport can register via the host website. The individual provides a name, alias, set of interests (e.g. baseball and hockey), language, team affiliation (e.g. a supporter of Boston Red Sox) and any additional information. The participant is assigned a Participant ID by the system.

Server 100 contains an Events Database 104 which contains a dynamically updated list of current events, for example, a list of sports events broadcast live in the United States. In order for a debate to take place, there must be an event taking place, for which there exist in the Participant Database at least two participants who hold opposing views. For example, a World Series baseball game between the Red Sox and the Giants and where one participant is a Red Sox supporter and the other is a Giants supporter. Furthermore, the participants, where possible, must be of a similar quality, or rank (explained below) in order for the debate to be balanced and entertaining.

Once selected (explained below) the debating participants 112a, 112b connect to server 100 via a network 108 (e.g. the Internet). Transmissions 110, audio or combined audio-visual, are transmitted from the first participant to the second participant via the server. Likewise, transmissions from the second participant are transmitted to the first participant via the server. The transmissions 110 are broadcast, substantially simultaneously, to an online forum on an internetwork, such as the Internet. Potentially, an additional participant or participants could be added to the online debate. Each participant needs at least basic communications equipment for sending audio or audio-visual transmissions over the Internet. Exemplary, each participant has at least a computer or computing device connected to the Internet, a microphone and/or web camera connected to the computer and relevant software for receiving and transmitting visual and/or audio transmissions over the Internet to server 100 for purposes of the debate. Furthermore, the device must facilitate the reception of audio or audio/visual transmissions over the Internet and broadcasting these transmissions to the participant (e.g. a monitor, speakers/earphones, I/O interfaces). All of the aforementioned requirements are also present in certain mobile devices, e.g. Smartphone cellular devices.

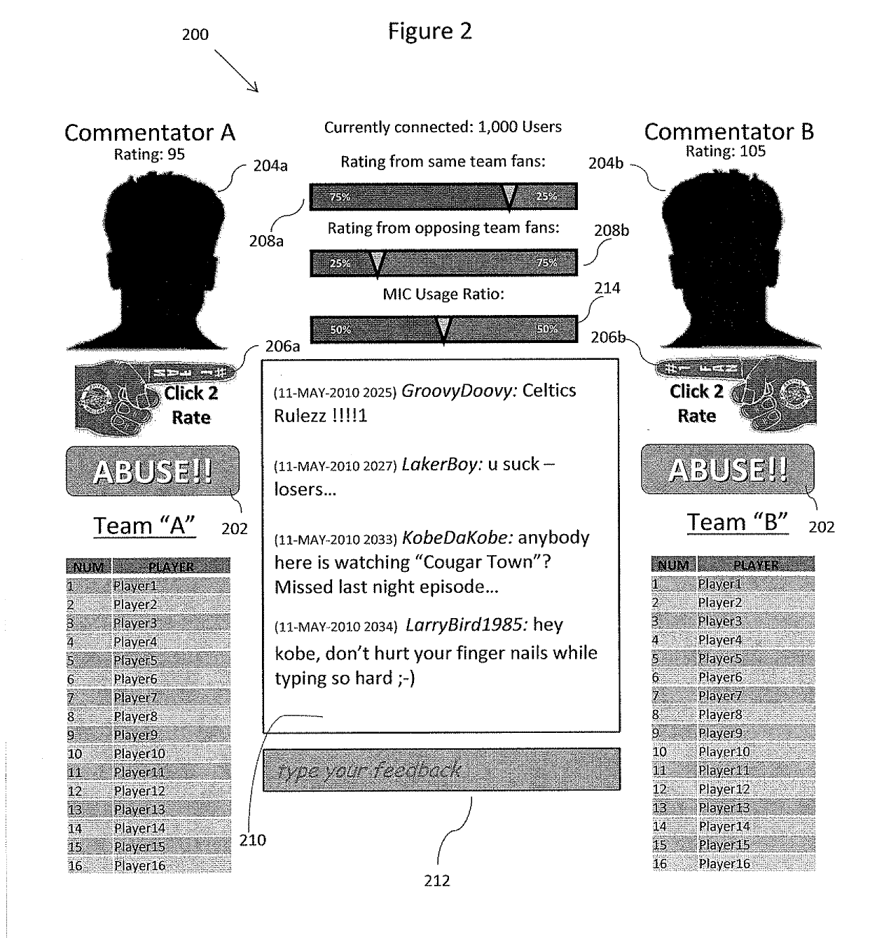

A simplified depiction of an exemplary online forum is shown in FIG. 2. The debate can be broadcast to the online forum, a webpage 200 hosted on a website. A first and a second commentator avatar/representation (204a, 204b), are featured. In the aforementioned audio/visual configuration the representative avatar may be replaced with a descriptive icon, as the participating commentators are visible in this configuration. In the case of more than two participants, each participant or group of participants can be individually identified.

Potentially, the current invention can be implemented as peer-to-peer (P2P) technology, whereby a client is downloaded by users/participants and whereby the data is transmitted directly between peers currently online. Alternatively, a VoIP, instant messaging platform or similar technology can be used to implement the current system. Skype™ is a potential platform on which to provide the current system.

Feedback comment area 212 allows the audience to provide written feedback on the debate. The feedback, in the form of text comments, can include emoticons and other additions as are well known in the art. The comments are received at server 100 via the forum and displayed in the “All comments” area 210. In addition to the comments that are received in real-time as well as post debate, the audience can rate the debate itself when it ends.

Each commentator can be rated individually. Exemplarily, an audience member can provide respective ranking feedback by clicking on a drop-down menu, and ranking the commentator by selecting a ranking equivalent from the drop-down menu. Of course, any ranking method can be employed, which will provide a numerical equivalent which is included in the ranking calculation of the participating commentators. In FIG. 2, the rating method works as follows: Whenever an audience member believes that the commentator has made a worthy remark or comment the audience member can click on the rating button 206a/206b to add a rating point to the commentator. The button remains depressed for a short period of time and then becomes un-depressed and available for use again. Each time the rating button is clicked the voting slider 208a, 208b representing the percentage of votes for each respective commentator/team is adjusted. Slider 208a, which represents rating from same team (likeminded) fans shows 75% in favor of Commentator A 204a, indicating that 75% of the rating votes accumulated from like-minded fans of both Team A and Team B were in favor of Commentator A 204a. Slider 208b, which represents rating from opposing team (non-likeminded) fans shows 25% in favor of Commentator A 204a, indicating that 75% of the rating votes accumulated from non-likeminded fans of both Team A and Team B were in favor of Commentator B 204b. In summary, clicking on the rating button gives positive percentage ratings to the relevant commentator, either from likeminded fans or from non-likeminded fans, and the difference in the origin of the rating votes is represented on the different sliders.

A further aspect of the current system is a microphone usage ratio factor 214 which represents to relative microphone usage of a participant. This factor can be included in the ranking calculation. A further enhancement of this component is a voice recognition unit for registering various voices which broadcast over the same microphone. For example, in the abovementioned scenario whereby two participants debate over a single device, the voice recognition component will allow for the accurate assignment of microphone usage ratio to each respective participant. Furthermore, in the event of numerous participants commentating over a single device (e.g. one group debating with a second group), each individual participant will be assigned the relative percentage of microphone usage he used. Clicking on abuse button 202 opens a communication box (not shown), allowing submission of complaints in regards to suggestive/inappropriate language being used or any other form of dissatisfaction caused to the audience by the debate.

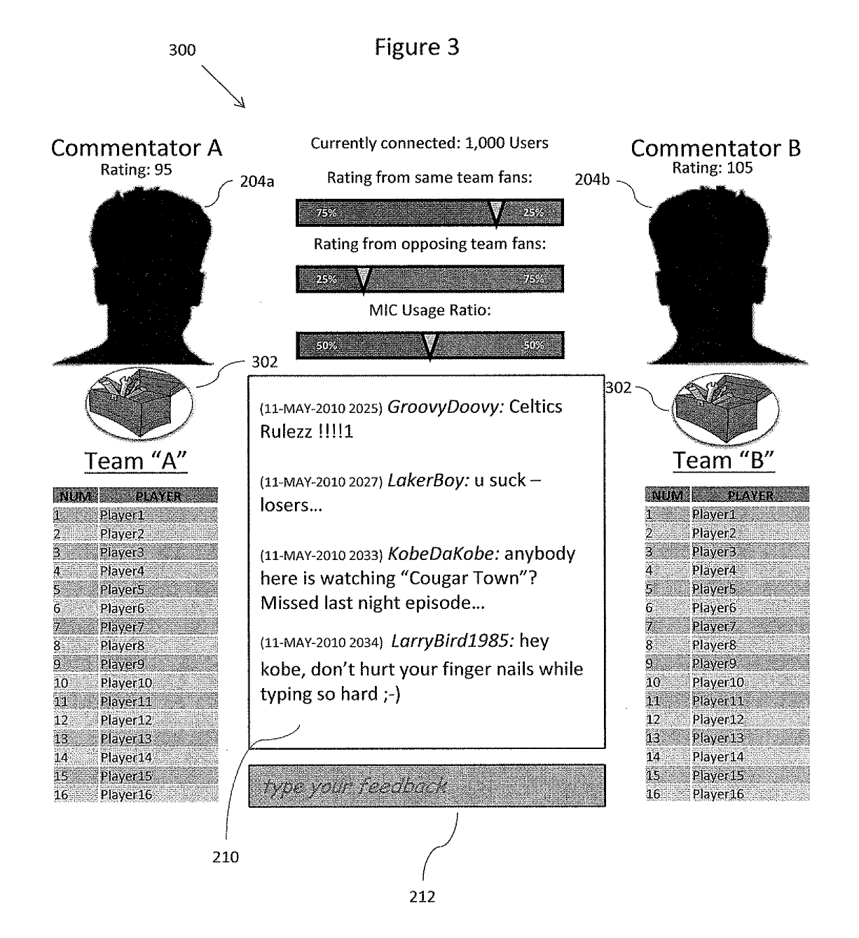

FIG. 3 depicts an exemplary simplified webpage 300 which is viewed by the participants of the debate, but not the audience. Each commentator has a toolbox icon 302 which, once clicked, gives the commentator access to a number of tools at his disposal. Exemplarily, the commentator can select paid advertising to display as his sponsor, or partial sponsor. Further exemplarily, the commentator can select visual effects tools to manipulate a designated area on the audience webpage. May other functions and tools, which are all known in the art, are envisioned to be applied in the online forum interface.

In the current configuration, exemplarily, the respective commentator ranking is calculated according to audience feedback and microphone usage ratio. Each participating commentator is given an initial ranking (e.g. one point). According to the registration information, the audience members are designated as either likeminded or non-likeminded members. For instance, in most embodiments, a likeminded audience member is a supporter of the same team as the commentator. Conversely, in these embodiments, a non-likeminded audience member is a supporter of opposing team. This factor is taken into consideration when calculating the numerical value of the respective ranking feedback of the participants. Potentially, the rating of a non-likeminded audience member would have a higher value than the rating of a likeminded member, as this choice is considered more objective. The ranking values (as explained above) are added to the calculation and an algorithm is applied so that values are relative to the number of users, to provide a balanced ranking for each commentator, so that a debate that was viewed by a large audience and a small audience would still return an absolute ranking value that is not out of proportion due to the large or small number of audience members. Of course, audience size is a contributing factor that is included in the calculation. In a similar vein, the rating of the entire debate may also a variable in the calculation, as can the number of debates participated in overall.

The debating participants, can be matched by the Matching module 106 on the server based on a number of criteria, namely: (1) a randomized selection between similarly ranked participants; (2) an audience member proposition, proposing a debate between two participants; (3) direct request by at least one participant. To facilitate audience member proposition, dropdown menus (not shown) allow audience members to select a first and second commentator whom they wish to debate together. The dropdown selection area contains the list of registered participants from whom an audience member can make his selection. Potentially, more than two participants can be selected to participate together. An alternative interface would provide additional options, such as adding additional participants and/or group(s) to a debate or selection.

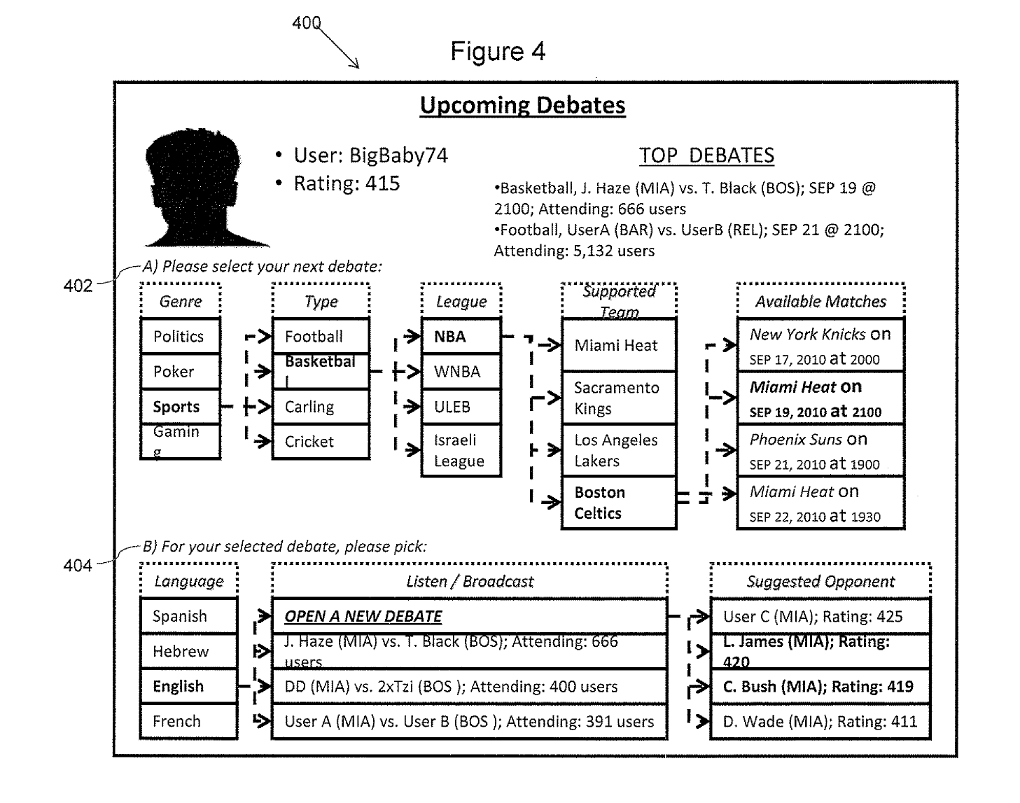

In an alternative embodiment, the exemplary website hosting the online forum would include various web pages dedicated to different aspects of the events, e.g. sports. At least one webpage is dedicated to the presenting a list of current or recorded debates from which an audience member can choose a desired debate to view. FIG. 4 depicts an exemplary simplified webpage via which a user or participant can access the broadcasts. A first area 402 depicts a series of menus from which to select an event. Exemplarily, the events can be listed according to category such as, but not limited to: Genre (e.g. politics, poker, sports, gaming). Once a genre is selected the ‘Type’ menu displays the available event types (e.g. football, basketball, baseball or cricket). If ‘Basketball’ is selected, a ‘League’ menu displays various leagues which are available. Exemplarily the NBA, WNBA, ULEB and. Israeli League are displayed. Once a selection is made, the list of supported teams is displayed. Once the user or participant has selected a team which he supports, a list of available matches is displayed from which to select an event. After selecting an event, the user or participant goes to a second area 404 to select a debate. Exemplarily, the first criterion is language (e.g. all debates taking place in English and/or Spanish). Once the language has been selected (e.g. English) a list of debates is displayed from which a user can select a live or scheduled debate to listen to. There is also the option of selecting a new debate in which to participate, as is shown in FIG. 4. Once selected, a further menu appears with a list of suggested opponents from which to select a desired debating opponent. Of course many variations and modifications to the selection page are envisioned.

Furthermore, the website can offer standard facilities and applications as are well known in the art, such as, but not limited to: registration for periodic newsletters, RSS feeds, Twitter, Facebook, blog posts and the like. In addition, applications for mobile devices (e.g. iPhone, Android etc.) allow audience members to connect to the website and/or receive the transmissions on their mobile devices.

Potentially, an audience member can be attending the event (e.g. a baseball game) and desire to hear the commentary debate via his mobile device. In a further application, the debate participants can be in attendance at the event and transmit/broadcast/debate over their mobile devices. Furthermore, the two debating participants can be in proximity of each other, at the event (or a remote location), and debate the event over two separate mobile devices, or even the same device. In the event that the debating participants are in proximity of each other (whether at the event or a remote location) using separate devices or are broadcasting over a single device (whether a mobile cellular device or a standard computer, such as a desktop PC)—the transmissions from both participants can potentially only be broadcast to the online forum but not to each other, as the participants are able to see/hear each other without the assistance of the system. In a further embodiment, a group of commentators can debate with another group or other groups and either be ranked individually or as a group.

In a further embodiment of the invention, participants may debate an online gaining event currently taking place. Online gaming is growing industry, in which communities of online garners play games together or in competition with one another. Whereas in the past, viewing online gaming was essentially participation based (i.e. you had to take part in the game in order to view it), the industry is branching out to become a spectator ‘sport’ as well. That is to say that an online game between two individuals can be viewed by additional spectators. For example, Jack from Idaho competes against Hugh from Detroit in an online game of basketball. Jack controls one team while Hugh the other. Spectators can log onto the online server hosting the online game (e.g. www.onlive.com) and view the game between Jack and Hugh. The current invention can be applied to the online gaming industry in a fashion similar to the sporting industry. An online game is simply an additional real-time event that is taking place and about which participants can commentate and debate.

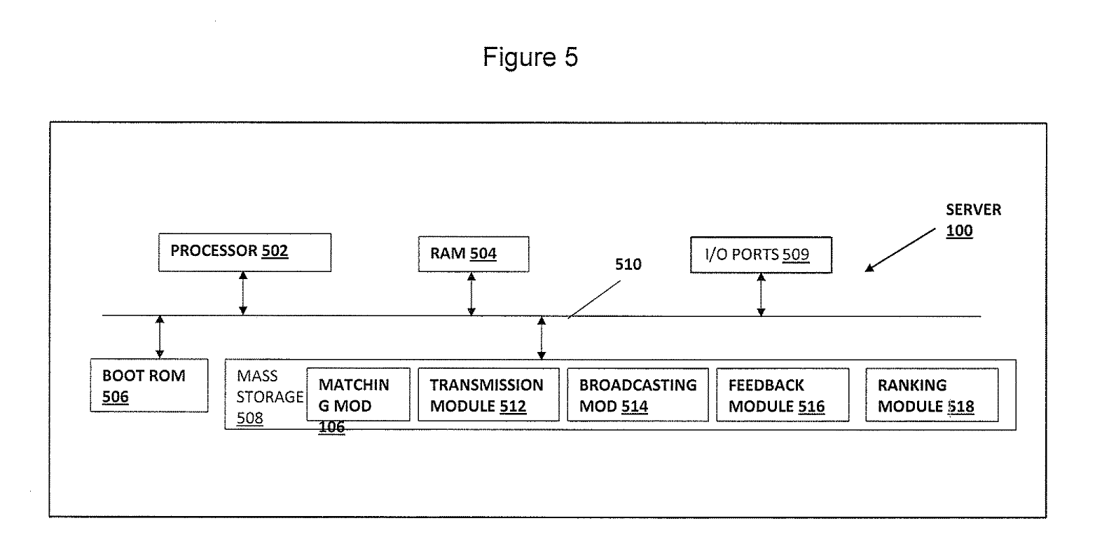

Server 100 can also be embodied in firmware, in hardware, or in any suitable combination of hardware, firmware and software. FIG. 5 is a software embodiment server 100. Server 100 includes a processor 502, RAM 504, boot ROM 506, a mass storage device (hard disk) 508 and Input/Output ports 509, all communicating via a common bus 510. The hard disk 508 has stored therein code modules for effecting various functions. The code modules are loaded into RAM 504 by the Operating System (not shown) and are executed by processor 502. Among the code modules there are included: Matching module 106, a Transmission module 512, a Broadcasting module 514, a Feedback module 516 and a Ranking module 518. All communications between the server 100, the participants and the online forum take place via the I/O ports 509.

The functions of Matching module 106 have been described above. Transmission module 512 is for receiving and relaying transmissions between debating participants. The Broadcasting module 514 is for broadcasting the transmissions to the online forum substantially simultaneously to the functioning of the Transmission module. The Feedback module 516 is for receiving audience feedback via the online forum and displaying that feedback on the forum. The feedback includes comments relating to the commentators who are debating at that time. The Ranking module 518 is for receiving ranking information (as detailed above) from the audience via the online forum and calculating the respective rankings of each of the participants, based on the ranking feedback.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of providing an online commentary debate comprising the steps of:
a. selecting a first and second participant;
b. receiving a first set of transmissions from said selected first participant and relaying said first set of transmissions to said selected second participant;
c. receiving a second set of transmissions from said second participant and relaying said second set of transmissions to said first participant; and
d. broadcasting both said sets of transmissions to an online forum on an internetwork, substantially simultaneously to said reception of said transmissions;

2. The method of claim 1 further including the step of:
e. receiving and relaying transmissions from at least one additional participant to and from said first and second participants.

3. The method of claim 1 wherein said internetwork is The Internet.

4. The method of claim 1 further including the step of:
e. receiving audience feedback, via an interface for receiving said feedback on said online forum.

5. The method of claim 4 further including the step of:
f. displaying said audience feedback on said interface.

6. The method of claim 5 wherein said interface is a webpage.

7. The method of claim 6 wherein farther including the step of:
g. receiving respective ranking feedback of said participants from said audience.

8. The method of claim 7 further including the step of:
h. assigning respective ranking to said participants, said ranking based on said ranking feedback.

9. The method of claim 8 wherein said ranking is calculated based on a plurality of indicators selected from the group consisting of:
a. ranking from likeminded audience members;
b. ranking from non-likeminded audience members;
c. number of debates participated in by said participant;
d. previous ranking of said participant;
e. ranking from audience members of said debates participated in by said participant;
f. number of audience members in attendance of said debates participated in; and
g. percentage of microphone usage by said participant during a debate.

10. The method of claim 1 further including the step of:
e. assigning initial rankings to said participants;

11. The method of claim 1 wherein said selection of said first participant and said second participant is effected by a technique selected from the group consisting of:
a. randomized selection based on ranking similarities;
b. audience member proposition; and
c. direct request by at least one said participant.

12. The method of claim 1 wherein said transmissions include audio content;

13. The method of claim 1 wherein said transmissions include audio and video content;

14. A system for broadcasting a commentary debate, comprising a server configured:
a. to select a first and second participant;
b. to receive a first transmission from said first selected participant and relay said first transmission to a second selected participant;
c. to receive a second transmission from said second participant and relay said second transmission to said first participant; and
d. to broadcast both said sets of transmissions to an online forum on an internetwork, substantially simultaneously to said reception of said transmissions.

15. The system of claim 14 wherein said server is further configured to receive feedback from an audience;

16. The system of claim 15 wherein said server is further configured to display said feedback to said online forum.

17. The system of claim 14 wherein said server is further configured to receive participant ranking from said audience.

18. A computer-readable medium operative to provide a system for broadcasting a commentary debate comprising:
a. a matching module for selecting a first and second participant;
b. a transmission module for receiving a first transmission from said first participant and relaying said first transmission to said second participant;
c. said transmission module for receiving a second transmission from said second participant and relaying said second transmission to said first participant; and
d. a broadcasting module for broadcasting both said sets of transmissions to an online forum on an internetwork, substantially simultaneously to said reception of said transmissions.

19. The computer-readable medium of claim 18 further comprising:
e. a feedback module for receiving audience feedback via said online forum and displaying said feedback on said online forum.

20. The computer-readable medium of claim 18 further comprising:
e. a ranking module for receiving ranking information from an audience via said online forum and calculating a participant ranking based on said ranking information.
